(19) United States
(12) Patent Application Publication
(10) Pub. No.: US 2007/0077407 A1
(43) Pub. Date: Apr. 5, 2007

(54) Composite article having oleophobic properties and method of manufacture

(75) Inventors: Karmin Lorraine Olson, Kansas City, MO (US); Alan Smithies, Overland Park, KS (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/241,425

(22) Filed: Sep. 30, 2005

(51) Int. Cl. B32B 3/26; B32B 9/00

(52) U.S. Cl. 428/304.4; 428/318.4

(57) ABSTRACT

A composite article includes a base material, and a porous membrane laminated with the base material. The porous membrane has hydrophobic properties and includes at least one of expanded polytetrafluoroethylene, woven polytetrafluoroethylene, and non woven polytetrafluoroethylene. A coating layer is formed on at least a portion of the porous membrane. The coating layer has oleophobic properties and includes at least one of a perfluoro alkyl acrylic copolymer and a perfluoro alkyl methacrylic copolymer.

### BACKGROUND OF THE INVENTION

This invention relates generally to composite articles, and more specifically to porous membranes having oleophobic properties.

It is known that a porous membrane may have at least one property that is limited by the material that the membrane is made from. For example, a porous membrane made from an expanded polytetrafluoroethylene (ePTFE) material has an affinity for oil (sometimes referred to as being “oleophilic”). Such ePTFE membranes may be used, for example, as filter media for, for example, air pollution control. However, although generally air permeable, the ePTFE membranes may absorb and/or adsorb oil. Absorbing and/or adsorbing oil can affect the air permeability in the area of the membrane that absorbed and/or adsorbed the oil, such that at least some portions of the membrane may no longer allow air flow therethrough. For example, while porous membranes used as filter media for air pollution control function by allowing airflow therethrough, they may have a relatively small pore size for capturing fine dust particles. However, the membrane's relatively small pores may become “fouled” by absorbing and/or adsorbing oil and oily contaminants in the dust. The oil and oily contaminants may impair the membrane's ability to filter the dust and/or other contaminants by blocking airflow through the membrane pores, as well as covering the membrane's filtration surfaces.

At least some known methods of protecting an ePTFE membrane from oil contamination include attaching a continuous hydrophilic film to the ePTFE membrane to protect one side of the ePTFE membrane from oil. However, such a structure may not be air permeable and the hydrophilic film must contain moisture to transmit the moisture through the membrane, which may result in a heavier membrane. Other known methods of protecting an ePTFE membrane from contamination by oil include treating the membrane with an oleophobic coating that does not completely obstruct the pores in the membrane. Accordingly, air flow through the ePTFE membrane is permitted while the membrane remains substantially protected from oil contamination. However, the effectiveness of such an oleophobic treatment may depend on a particle size of the treatment material relative to an effective pore size in the ePTFE membrane.

Moreover, oleophobic coatings are sometimes applied to the membrane before the membrane is laminated with a base material or substrate, such as a felt or a woven fabric. However, heat from some lamination processes that bond the membrane to the base material may damage the oleophobic coating. Furthermore, some membranes may not be strong enough to receive the oleophobic coating. For example, a weight of some air pollution filtration membranes may cause the membrane to be damaged by application of the oleophobic coating, possibly reducing the effectiveness and/or the lifespan of the membrane.

### BRIEF DESCRIPTION OF THE INVENTION

In one aspect, a composite article includes a base material, and a porous membrane laminated with the base material. The porous membrane has hydrophobic properties and includes at least one of expanded polytetrafluoroethylene, woven polytetrafluoroethylene, and non woven polytetrafluoroethylene. A coating layer is formed on at least a portion of the porous membrane. The coating layer has oleophobic properties and includes at least one of a perfluoro alkyl acrylic copolymer and a perfluoro alkyl methacrylic copolymer.

In another aspect, a method is provided of making a composite article having oleophobic properties. The method includes providing a base material, providing a porous membrane having hydrophobic properties and comprising a plurality of pores, laminating the base material with the porous membrane, and applying a coating of a coating composition having oleophobic properties onto surfaces defining the pores in the porous membrane after the porous membrane has been laminated with the base material.

### BRIEF DESCRIPTION OF THE DRAWINGS

FIG. 1 is a schematic sectional view of an exemplary embodiment of a composite article.

FIG. 2 is an enlarged schematic plan view of a portion of the exemplary composite article shown in FIG. 1.

FIG. 3 is an enlarged schematic sectional view of a portion of the exemplary composite article shown in FIG. 1 illustrating a coating layer formed on a membrane of the exemplary composite article.

FIG. 4 is a scanning electron microscope (SEM) photomicrograph of a portion of the porous membrane of the exemplary composite article shown in FIG. 1.

FIG. 5 is a schematic view of an exemplary embodiment of a system for fabricating the exemplary composite article shown in FIG. 1.

### DETAILED DESCRIPTION OF THE INVENTION

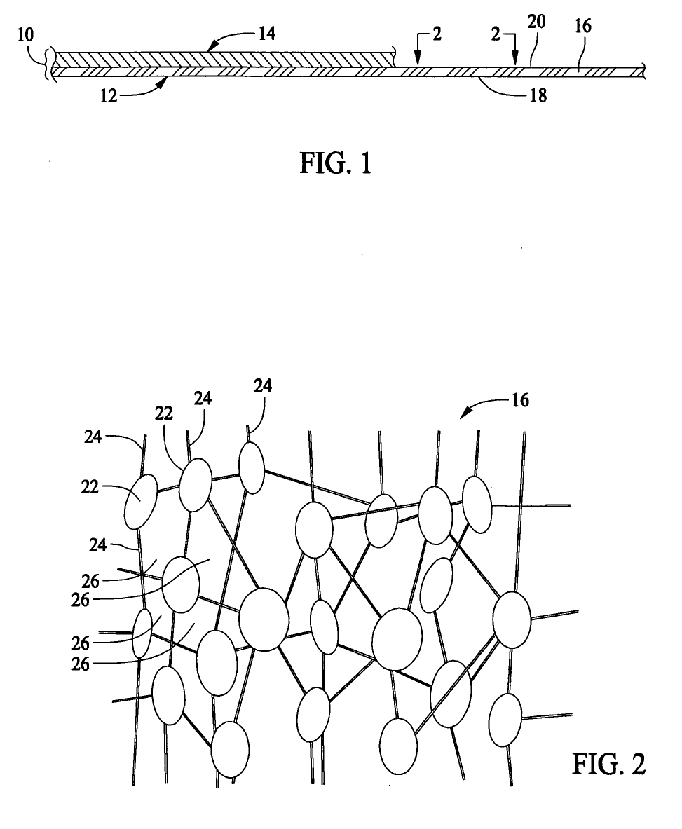

FIG. 1 is a schematic sectional view of an exemplary embodiment of a composite article 12. Composite article 12 can be used, but is not limited to being used, as filter media. Although composite article 12 may be used to filter anything, in some embodiments composite article 12 is filter media for air pollution control. In the exemplary embodiment, composite article 12 is air permeable and offers release properties for filtered contaminants, which may improve the efficiency of composite article 12 and/or may increase a lifespan of composite article 12. Composite article 12 is generally oleophobic and offers protection from contaminants, such as, but not limited to, hydrocarbon-containing dust, for example asphalt dust and/or pet coke dust. The term “air permeable” is used herein to describe the ability of composite article 12 to permit air to pass through it. The term “oleophobic” is used herein to describe the resistance of a material to contamination from absorbing oils, greases, soap, detergent, and/or body fluids, such as perspiration.

Composite article 12 generally includes a base material 14 laminated with a porous membrane 16. Base material 14 may be any type of material that meets performance and/or other criteria established for a predetermined application in which composite article 12 will be used. For example, in some embodiments base material 14 includes polypropylene, polyethylene, polyester, acrylic, polyphenylene sulfide (PPS), aramid, polyimide, glass, and/or polytetrafluoroethylene (PTFE). Although base material 14 may be formed in other ways, base material 14 may be woven material and/or non-woven material, such as but not limited to, needle felt, spunbond, extruded mesh, dry-lattice, cast film, and/or hydro-engtangled materials. In some embodiments, and for example, base material 14 may be formed using heat, compression, and/or chemical treatment.

FIG. 2 is an enlarged schematic plan view of a portion of composite article 12. Membrane 16 is porous, and in some embodiments microporous, with a three-dimensional matrix or lattice type structure of a plurality of nodes 22 interconnected by a plurality of fibrils 24. Membrane 16 is made from any suitable material, such as, but not limited to, expanded polytetrafluoroethylene (ePTFE) and/or a PTFE fabric. For example, membrane 16, in one exemplary embodiment, is made by extruding a mixture of polytetrafluoroethylene (PTFE) fine powder particles (e.g., available from DuPont of Wilmington, Del. under the name TEFLON® fine powder resin) and lubricant. The extrudate is then calendared. The calendared extrudate is then “expanded” or stretched in at least one direction to form fibrils 24 connecting nodes 22 in a three-dimensional matrix or lattice type of structure. “Expanded” is intended to mean sufficiently stretched beyond the elastic limit of the material to introduce permanent set or elongation to fibrils 24. Membrane 16, in one exemplary embodiment, is heated or “sintered” to reduce and minimize residual stress in the ePTFE material. However, in alternate embodiments, membrane 16 is unsintered or partially sintered as is appropriate for the contemplated use of membrane 16. In some embodiments, the size of a fibril 24 that has been at least partially sintered is in the range of between about 0.05 micron and about 0.5 micron in diameter, taken in a direction normal to the longitudinal extent of fibril 24.

Other materials and methods can be used to form a suitable membrane 16 that has an open pore structure. For example, other suitable materials include, but are not limited to, polyolefin, polyamide, polyester, polysulfone, polyether, acrylic and methacrylic polymers, polystyrene, polyurethane, polypropylene, polyethylene, cellulosic polymer and combinations thereof. Other suitable methods of making a porous membrane 16 include, but are not limited to, foaming, skiving or casting any of the suitable materials.

Surfaces of nodes 22 and fibrils 24 define numerous interconnecting pores 26 that extend completely through membrane 16 between opposite major side surfaces 18 and 20 (shown in FIG. 1) of membrane 16 in a tortuous path. In some embodiments, the average size of pores 26 in membrane 16 is sufficient to be deemed microporous, but any pore size can be used. In one exemplary embodiment, a suitable average size for pores 26 in membrane 16 is between about 0.01 microns and about 10 microns, and in another embodiment between about 0.1 microns to about 5.0 microns.

Although membrane 16 may have any weight, in some embodiments membrane 16 has a weight of between about 0.02 and about 0.2 ounces per square yard. For example, in some embodiments membrane 16 has a weight of between about 0.03 and about 0.09 ounces per square yard.

Membrane 16, while having excellent hydrophobic properties, is oleophilic. More specifically, membrane 16 is susceptible to contamination by absorbing and/or adsorbing oil and/or oily contaminants. Once such oil and/or oily contaminants have been absorbed and/or adsorbed, the contaminated regions of membrane 16 are considered “fouled” because the oil and other contaminants, for example, at least partially block pores 26 such that membrane is no longer considered air permeable and/or reduce an overall filtration surface area by covering surfaces 18 and 20 and/or surfaces of fibrils 24 and/or nodes 22.

To describe how such oil and other contaminants are absorbed and/or adsorbed by membrane 16, the concept of a liquid drop “wetting” a solid material will be briefly described. The physical and thermodynamic definition of “wetting” is based on the concepts of surface energy and surface tension. Liquid molecules are attracted to one another at their surfaces. This attraction tends to pull the liquid molecules together. Relatively high values of surface tension mean that the molecules have a strong attraction to one another and it is relatively more difficult to separate the molecules. The attraction varies depending on the type of molecule. For example, water has a relatively high surface tension value because the attraction in water molecules is relatively high due to hydrogen bonding, while some oils have relatively low surface tension values.

The concept of “wetting” is a function of the surface energy of a liquid (′Y_{SL}), the surface energy of a solid (′Y_{SA}) and the surface tension of a liquid ( [symbol] _{LA}), and is often described by the Young-Dupre equation below.
′Y_{SL}−′Y_{SA}= [symbol] _{LA}*Cos(θ) (1)

Contact angle θ is a measure of the angle defined between the surface of a liquid drop and the surface of a solid taken at the tangent edge of where the liquid drop contacts the solid, such that when the contact angle θ is about 0°, a liquid will spread to a thin film over the solid surface. By comparison, a solid and liquid combination with a contact angle θ of about 180° causes the liquid to form a spherical drop on the solid surface. When a contact angle θ between about 0° and about 90° exists, a liquid will “wet” the solid it is contacting and the liquid will be drawn into pores, if any, existing in the surface of a solid. When the contact angle θ is more than about 90°, a liquid will not wet the solid and there will be a force needed to drive the liquid into any existing pores in the solid.

The propensity of membrane 16 to adsorb oil and/or oily contaminants, as well as whether or not oil and/or oily contaminants would be adsorbed into pores 26, is a function of the surface energy of membrane 16, the surface tension of the oil and/or oily contaminants, the relative contact angle between membrane 16 and the oil and/or oily contaminants, and the size or effective flow area of pores 26. One way to prevent entry of oil and/or oily contaminants into pores 26 is to make pores 26 extremely small. However, this may be undesirable or impractical because it may reduce an air permeability of membrane 16. Another way to prevent or minimize the absorption and/or adsorption of oil and/or oily contaminants by membrane 16 is to provide the surfaces of membrane 16 with a lower surface tension than the surface tension of the oil and/or oily contaminants, and a relative contact angle more than 90°. Surface energy and surface tension values are typically given in units of dynes/cm. Examples of surface energies and relative surface tensions are listed in the table below:

| | Surface Energy | Surface Tension |
|---|---|---|
| Material | (dynes/cm) | (dynes/cm) |
| ePTFE | 30 | |
| Deionized water | | 72 |
| tap water | | varies with |
| | | source |
| Acetone | | 23.5 |
| Isopropyl alcohol (100%) | | 20.9 |
| Kaydol (AATCC 118 Test | | 31.5 |
| Liquid, Oil Repellency Grade | | |
| Number 1) | | |
| n-hexadecane (AATCC 118 | | 27.3 |
| Test Liquid, Oil Repellency | | |
| Grade Number 3) | | |
| n-tetradecane (AATCC 118 | | 26.4 |
| Test Liquid, Oil Repellency | | |
| Grade Number 4) | | |
| n-dodecane (AATCC 118 Test | | 24.7 |
| Liquid, Oil Repellency Grade | | |
| Number 5) | | |
| n-decane (AATCC 118 Test | | 23.5 |
| Liquid, Oil Repellency Grade | | |
| Number 6) | | |
| n-octane (AATCC 118 Test | | 21.4 |
| Liquid, Oil Repellency Grade | | |
| Number 7) | | |
| n-heptane (AATCC 118 Test | | 14.8 |
| Liquid, Oil Repellency Grade | | |
| Number 8) | | |

The more that the surface tension of the oil and/or oily contaminants is above the surface energy of membrane 16 and/or the more the relative contact angle is above 90°, the less likely the oil and/or oily contaminants will wet membrane 16.

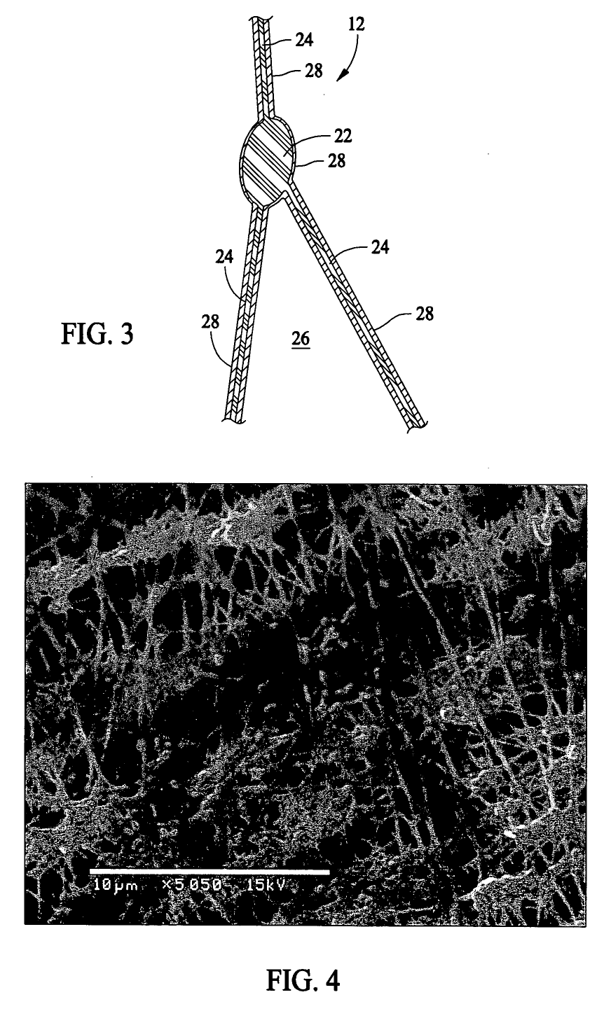

FIG. 3 is an enlarged schematic sectional view of a portion of composite article 12 illustrating a coating layer 28 formed on membrane 16. Coating layer 28 is an oleophobic coating that may enhance oleophobic and hydrophobic properties of membrane 16 without compromising an air permeability of membrane 16. For example, coating layer 28 may reduce the surface energy of membrane 16 so fewer oils and oily contaminants are capable of wetting membrane 16 and entering pores 26. Moreover, coating layer 28 may increase the contact angle for oils and/or oily contaminants relative to membrane 16. Coating layer 28 includes coalesced oleophobic fluoropolymer solids. Although coating layer 28 may include other fluoropolymer solids, in some embodiments coating layer 28 is formed from a coating composition including fluoropolymer solids that include an acrylic-based polymer with fluorocarbon side chains. The side chains have been found to have a relatively low surface tension, so it is desirable to extend these away from membrane 16. For example, the oleophobic fluoropolymer solids used in coating layer 28 are, in some embodiments, in the form of a stabilized water-miscible dispersion of perfluoro alkyl acrylic copolymer solids and/or perfluoro alkyl methacrylic copolymer solids, such as, but not limited to, water-based dispersions of Zonyl® 8195, 7040, 8412, and/or 8300, available from Dupont of Wilmington, Del. In some embodiments, the oleophobic fluoropolymer solids may also contain relatively small amounts of acetone and ethylene glycol or other water-miscible solvents and surfactants that were used in the polymerization reaction when the fluoropolymer solids were made.

In some embodiments, the dispersion of oleophobic fluoropolymer solids is stabilized with a stabilizing agent, such as, but not limited to, deionized and/or demineralized water. The stabilizing agent reduces the propensity of the oleophobic fluoropolymer solids from settling out and agglomerating to a size which cannot enter a pore 26 in membrane 16. The stabilized dispersion of oleophobic fluoropolymer solids is then diluted in one or more suitable solvents to form the coating composition that will form coating layer 28. Although other solvents may be used, suitable solvents may include, but are not limited to, water, ethanol, isopropyl alcohol, acetone, methanol, n-propanol, n-butanol, N—N-dimethylformamide, methyl ethyl ketone and water soluble e- and p-series glycol ethers. Moreover, although the solvents may have other surface tensions, in some embodiments, the coating composition includes a solvent having a surface tension of less than about 31 dynes per centimeter. Although the coating composition may include other amounts, in some embodiments, the coating composition forming coating layer 28 includes an amount of oleophobic fluoropolymer solids in the range of about 0.1 wt % to about 10 wt % based on a total weight of the coating composition. For example, in some embodiments, the coating composition includes oleophobic fluoropolymer solids in the range of about 0.5 wt % to about 1.5 wt %. Although the coating composition may include other amounts of solvent, other than water, in some embodiments, the coating composition that forms coating layer 28 includes an amount of solvent, other than water, in the range of about 40 wt % to about 80 wt %. For example, in some embodiments the coating composition includes an amount of solvent, other than water, in the range of about 50 wt % to about 75 wt %. Although the coating composition may include other amounts of stabilizing agent, in some embodiments the coating composition forming coating layer 28 includes an amount of stabilizing agent in the range of about 5 wt % to 50 wt %. For example, in some embodiments the coating composition includes an amount of stabilizing agent in the range of about 15 wt % to about 25 wt %.

The coating composition forming coating layer 28 has a surface tension and a relative contact angle that enable the coating composition to wet pores 26 in membrane 16 such that pores 26 are coated with the oleophobic fluoropolymer solids in the coating composition. However, in some embodiments membrane 16 is wet with a solution containing a solvent before the coating composition is applied to membrane 16 such that the coating composition will pass through membrane pores 26 and “wet-out” surfaces of membrane 16. In some embodiments, a stabilizing agent and/or solvent is used to dilute an “as purchased” dispersion of oleophobic fluoropolymer solids to a predetermined solids content. It may be desirable to increase a ratio of the stabilizing agent to solvent to increase a stability of the coating composition. However, enough solvent must be present to ensure wetting of membrane 16 and flow of the coating composition into membrane pores 26.

Generally, and as will be described in more detail below, the coating composition is applied to membrane 16 to wet the surfaces of nodes 22 and fibrils 24 that define membrane pores 26, as well as side surfaces 18 and/or 20. The thickness of coating layer 28 and the amount and type of fluoropolymer solids in coating layer 28 may depend on several factors. These factors include the affinity of the solids to adhere and conform to the surfaces of nodes 22 and fibrils 24 that define membrane pores 26, the final solids content within the coating composition, the coating process, and/or whether abuse of membrane 16 during preparation of composite article 12 for use (such as, but not limited to, conversion to filter bags), during use, and/or during maintenance (such as, but not limited to, removal of captured particles) may crack, dislodge, damage or disrupt coating layer 28.

The coating composition is applied to membrane 16 such that substantially all of the surfaces of the nodes 22 and fibrils 24, as well as surfaces 18 and 20, are at least partially wetted and membrane pores 26 are not blocked. The coating composition adheres and conforms to the surfaces of nodes 22 and fibrils 24 that define membrane pores 26, in addition to surfaces 18 and/or 20. It is not necessary that the coating composition completely encapsulate the entire surface of a node 22 or fibril 24 (or of surfaces 18 and/or 20) or be continuous to increase oleophobicity of membrane 16, and therefore composite article 12. The coating composition is then cured by heating membrane 16 such that the oleophobic fluoropolymer solids flow and coalesce, and such that the stabilizing agents and solvents are removed. During the application of heat, the thermal mobility of the oleophobic fluoropolymer solids allows the solids to be mobile and flow around, engage, and adhere to surfaces 18 and/or 20, nodes 22, and fibrils 24, and therefore coalesce to form coating layer 28. At the relatively elevated temperature, the mobility of the oleophobic fluoropolymer solids also permits the fluorocarbon side chains to orient themselves to extend in a direction away from surfaces 18 and 20, nodes 22, and fibrils 24. The finished coating layer 28 results from coalescing the oleophobic fluoropolymer solids on as many of the surfaces of nodes 22 and fibrils 24 defining membrane pores 26, as well as surfaces 18 and/or 20, as possible.

FIG. 4 is a scanning electron microscope (SEM) photomicrograph of a portion of membrane 16 having coating layer 28 thereon. The coalesced oleophobic fluoropolymer solids provide a protective oleophobic coating layer 28 on membrane 16 that does not completely block or “blind” the pores 26 in membrane 16, which could adversely affect air permeability through composite article 12. It can be seen from FIG. 4 that membrane pores 26 are not completely blocked. It will be apparent that some pores 26 in membrane 16 could be blocked, but such blockage is minimal and dependent on variables in the coating process and structure of membrane 16. Coating layer 28, thus, may improve or modify the oleophobicity of the material of membrane 16 to resist contamination from absorbing of contaminating materials such as oil and/or oily contaminants, without comprising air flow through composite article 12. For example, coating layer 28 may add a relatively low surface energy layer to membrane so that the relative contact angle of some oils and/or oily contaminants is greater than 90° which inhibits fouling of membrane 16, and therefore composite article 12.

In some embodiments, composite article 12 is air permeable to a sufficient degree for filtration of air. Although composite article 12 may have other air permeabilities, in some embodiments, composite article 12 has an air permeability of at least about 3.0 cubic feet per minute (CFM) per square foot of membrane 16, and in other embodiments, at least about 5.0 CFM per square foot of membrane 16, as measured by ASTM D737 testing. Although composite article 12 may have other oil repellency grades, in some embodiments, composite article 12 has an oil repellency grade of at least a number 3, and in other embodiments, at least a number 6, as determined in accordance with AATCC 118 test method.

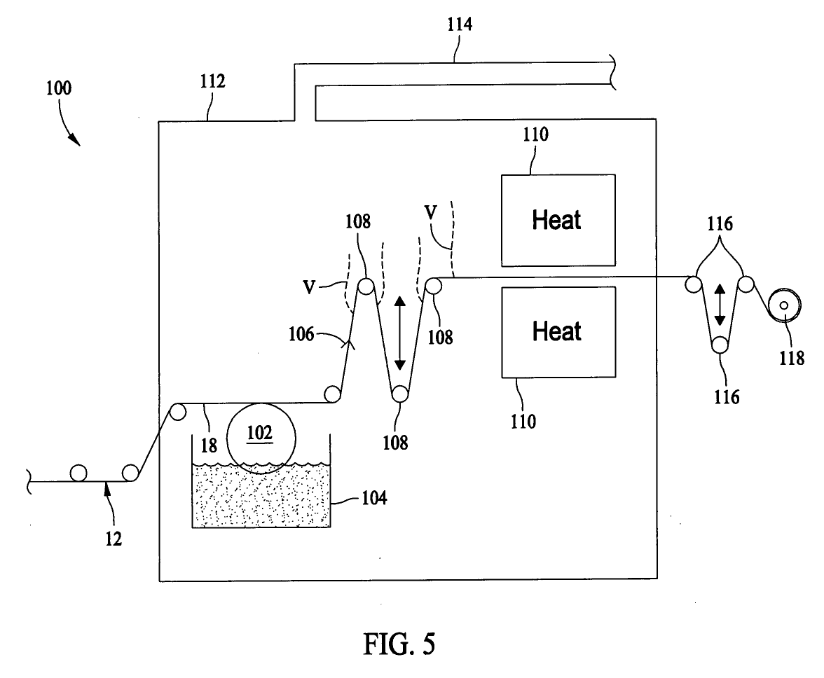

FIG. 5 is a schematic view of an exemplary embodiment of a system 100 for fabricating a composite article, such as composite article 12. Some known composite articles are fabricated by applying a protective oleophobic coating to the membrane before the membrane is laminated with a base material. However, depending on a temperature resistance of the protective oleophobic coating, heat from some lamination processes that bond the membrane to the base material may damage the protective oleophobic coating, possibly reducing the oleophobic properties of the coating and therefore the composite article. For example, lamination temperatures above 300° F. may damage some protective oleophobic coatings. Moreover, some membranes may not be durable enough to receive the protective oleophobic coating without being supported by the base material, possibly reducing the effectiveness and/or the lifespan of the membrane. For example, a weight, such as, but not limited to, between about 0.02 and about 0.2 ounces per square yard, of some air pollution filtration membranes may be insufficient to prevent the membrane from being damaged by application of the protective oleophobic coating.

Accordingly, to support membrane 16 during application of the coating composition, and to prevent coating layer 28 from being damaged from lamination temperatures, composite article 12 is fabricated by laminating base material 14 with membrane 16 before coating layer 28 is formed by application of the coating composition.

Although base material 14 may be laminated against side surface 18, in the exemplary embodiment base material 14 is laminated against membrane side surface 20. Base material 14 and membrane 16 may be laminated together using any suitable process, any suitable parameters, and using any suitable means. For example, and although base material 14 and membrane 16 may be laminated together at any temperature, in some embodiments, base material 14 and membrane 16 are laminated together using heat at a temperature of greater than about 300°. In one exemplary embodiment, base material 14 and membrane 16 are laminated together at a temperature of between about 680° F. and about 700° F. In some embodiments, and for example, base material 14 and membrane 16 are laminated together using an adhesive applied between membrane 16 and base material 14.

The coating composition can be applied to membrane 16 using any suitable process, such as, but not limited to, roll-coating, immersion (dipping), and/or spraying. In the exemplary embodiment, to apply the coating composition that forms coating layer 28, the laminated base material 14 and membrane 16 are directed over a roller 102 that is immersed within a reservoir 104 containing the coating composition. Specifically, composite article 12 is directed over roller 102 such that membrane side surface 18 contacts roller 102. Coating composition on roller 102 is thereby applied to membrane surface 18. As composite article 12 is directed over roller 102, base material 14 supports membrane 16 to facilitate preventing damage to membrane 16 from roller 102 and/or other components of system 100, whether described and/or illustrated herein. The coating composition impregnates membrane 16, wets the surfaces of the nodes 22 and fibrils 24 that define membrane pores 26, and wets surfaces 18 and 20.

Composite article 12 is directed off of roller 102 and a mechanism 106, such as, but not limited to, a pair of squeegees or doctor blades, engages composite article 12. Mechanism 106 facilitates spreading the coating composition and removing excess coating composition from composite article 12 to minimize the chance of blocking membrane pores 26. Any other suitable means for removing the excess coating composition may be used, such as, but not limited to, an air knife. Composite article 12 is then directed over rollers 108. The stabilizing agents, solvents, and/or any other fugitive materials are removed by air drying or other drying methods. The solvents typically evaporate by themselves but the evaporation can be accelerated by applying relatively low heat, such as, but not limited to, at least to about 212° F. Solvent vapor V generally moves away from composite article 12, as shown in FIG. 5. Removal of the stabilizing agents may require an affirmative step for drying, such as the application of heat.

Composite article is directed from rollers 108 to an oven having heat sources 110. In some embodiments, the reservoir 104 and heat sources 110 may be enclosed or vented with a hood 112. Hood 112 may be vented to a predetermined location through a conduit 114. Hood 112 removes and captures vapor V, such as, fugitive solvents and stabilizing agents, from composite article 12 and directs the captured material to the predetermined location for storage or disposal. In some embodiments, heat sources 110 each include two heating zones (not shown). The first heating zone would be a “drying zone” to apply relatively low heat to composite article 12, such as, but not limited to, about 212° F., to remove or evaporate any fugitive solvents and stabilizing agents that have not yet evaporated. The second heating zone would be a “curing zone” to coalesce the oleophobic fluoropolymer solids.

Heat sources 110, in the second heating zone if two are included, apply a temperature of equal to or less than about 300° F. for at least 10 seconds to cure the coating composition on composite article 12 and thereby form coating layer 28. In some embodiments, heat sources 110 apply heat in the range of about 260° F. to about 280° F. In other embodiments, heat sources 110 apply heat in the range of about 220° F. to about 240° F. Moreover, in some embodiments heat sources 110 apply heat to composite article 12 for between about 30 seconds and about 5 minutes. For example, in some embodiments heat sources 110 apply heat to composite article 12 for about 2 minutes. It should be understood that the temperature and duration of curing by heat sources 110 may depend on the selected coating composition, and/or the selected materials of membrane 16 and/or base material 14. In some embodiments, curing composite article 12 at a temperature equal to or lower than 300° F. facilitates preventing damage to membrane 16 that my affect an air permeability of composite article 12. For example, a temperature greater than 300° F. may shift membrane pores 26 such that they are blocked. The heat applied to composite article 12 permits the oleophobic fluoropolymer solids to reduce their surface tension to flow and spontaneously wet and better coat surfaces defining nodes 22 and fibrils 24, as well as membrane surfaces 18 and 20. The oleophobic fluoropolymer solids flow and coalesce around such surfaces to render composite article 12 oil and oily contaminants resistant. The amount and duration that the heat is applied to composite article 12 allows the oleophobic fluoropolymer solids to coalesce and orient so tails made of the fluorocarbon side chains (not shown) extend in a direction away from surfaces of membrane 16. Once cured, composite article 12 exits the oven and is directed over rollers 116 onto a take up reel 118.

Test Descriptions:

Oil Penetration Test

A challenge oil is dropped onto the surface of a sample of test material to visually assess the wetting of the liquid into the material. When wetted by the test oil, the samples generally change in appearance from opaque or semi-transparent to transparent. The number reported is that of the highest test oil number, having the lowest surface tension value, which did not wet the test specimen.

Test oils with numbers 1-8, as described in the AATCC Technical Manual were used.

Air Permeability Test

Air permeability is measured by a Frazier Air Permeability Tester per ASTM D737 or on a Textest FX 3300 Air Permeability Tester.

Without intending to limit the scope of the methods and articles described and/or illustrated herein, the following examples demonstrate how embodiments of the articles and methods described and/or illustrated herein may be practiced. Test results are provided below to demonstrate the experiments performed and the methodology used.

### MEMBRANE EXAMPLE

A microporous membrane made from ePTFE material was used. The membrane had an average pore size in the range of about 0.5 to 1.5 micron.

### Treatment Example 1

The membrane described above was laminated with a polyester material and treated with a diluted and stabilized Zonyl® 8195 dispersion to form a composite article. Specifically, an Oleophobic fluoropolymer dispersion (Zonyl® 8195) was mixed with about 25% water and about 75% Isopropyl Alcohol by volume to form a coating composition having 0.5 wt % oleophobic fluoropolymer solids.

The composite article was heated to about 250° F. for about 5 minutes to coalesce the solids onto the nodes and fibrils of the treated membrane. Most of the pores in the treated membrane were not “blinded” or closed off. The treated composite article displayed an air permeability of about 4.14 CFM per square foot and an oil hold out number of 6.

### Treatment Example 2

The membrane described above was laminated with a polyester material and treated with a diluted and stabilized Zonyl® 8195 dispersion to form a composite article. Specifically, an Oleophobic fluoropolymer dispersion (Zonyl® 8195) was mixed with about 25% water and about 75% Isopropyl Alcohol by volume to form a coating composition having 0.9 wt % oleophobic fluoropolymer solids.

The composite article was heated to about 250° F. for about 5 minutes to coalesce the solids onto the nodes and fibrils of the treated membrane. Most of the pores in the treated membrane were not “blinded” or closed off. The treated composite article displayed an air permeability of about 3.27 CFM per square foot and an oil hold out number of 8.

Exemplary embodiments of articles and methods are described and/or illustrated herein in detail. The articles and methods are not limited to the specific embodiments described herein, but rather, components of each article and steps of each method may be utilized independently and separately from other articles and steps described herein. Each article component and method step can also be used in combination with other article components and/or method steps.

When introducing elements of the methods and articles described and/or illustrated herein, including any and all embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

While the invention has been described in terms of various specific embodiments, those skilled in the art will recognize that the invention can be practiced with modification within the spirit and scope of the claims.

What is claimed is:

1. A composite article comprising:
a base material;
a porous membrane laminated with the base material, said porous membrane having hydrophobic properties and comprising at least one of expanded polytetrafluoroethylene, woven polytetrafluoroethylene, and non woven polytetrafluoroethylene; and
a coating layer formed on at least a portion of said porous membrane, said coating layer having oleophobic properties and comprising at least one of a perfluoro alkyl acrylic copolymer and a perfluoro alkyl methacrylic copolymer.

2. A composite article in accordance with claim 1 wherein said base material comprises a material selected from a group of materials comprising polypropylene, polyethylene, polyester, acrylic, polyphenylene sulfide (PPS), aramid, polymide, glass, and polytetrafluoroethylene, said base material being one of woven and non-woven.

3. A composite article in accordance with claim 1 wherein said porous membrane comprises a plurality of nodes and fibrils defining a plurality of interconnecting pores extending therethrough.

4. A composite article in accordance with claim 1 wherein said porous membrane comprises a weight of between about 0.02 and about 0.2 ounces per square yard.

5. A composite article in accordance with claim 4 wherein said porous membrane comprises a weight of between about 0.03 and about 0.09 ounces per square yard.

6. A composite article in accordance with claim 1 wherein said coating layer is formed from a coating composition comprising between about 0.1 and about 10 wt % solids based on the total weight of said coating composition.

7. A composite article in accordance with claim 6 wherein said coating composition comprises between about 0.5 and about 1.5 wt % solids based on the total weight of said coating composition.

8. A composite article in accordance with claim 1 wherein said coating layer is formed from a coating composition comprising a solvent having a surface tension of less than about 31 dynes per centimeter.

9. A composite article in accordance with claim 1 wherein said coating layer is formed from a coating composition comprising a solvent selected from a group of solvents comprising water, isopropyl alcohol, ethanol, and acetone.

10. A composite article in accordance with claim 1 wherein said coating layer is formed from a coating composition comprising between about 40% and 80% solvent.

11. A composite article in accordance with claim 1 wherein said composite article comprises an air permeability of at least about 3.0 CFM per square foot as measured in accordance with ASTM D737.

12. A composite article in accordance with claim 1 wherein said coating layer provides an oil repellency grade of at least a number 3 measured in accordance with AATCC 118 test method.

13. A composite article in accordance with claim 12 wherein said coating layer provides an oil repellency grade of at least a number 6 measured in accordance with AATCC 118 test method.

14. A method of making a composite article having oleophobic properties, said method comprising:
providing a base material;
providing a porous membrane having hydrophobic properties and comprising a plurality of pores;
laminating the base material with the porous membrane; and
applying a coating of a coating composition having oleophobic properties onto surfaces defining the pores in the porous membrane after the porous membrane has been laminated with the base material.

15. A method in accordance with claim 14 wherein said laminating the base material with the porous membrane comprises laminating the base material with the porous membrane at a temperature greater than about 300° F.

16. A method in accordance with claim 14 wherein said applying a coating of a coating composition comprises passing the porous membrane over a roller having the coating composition thereon.

17. A method in accordance with claim 14 further comprising curing the coating composition after the coating composition has been applied to the porous membrane at a temperature equal to or less than about 300° F.

18. A method in accordance with claim 17 wherein said curing the coating composition comprises curing the coating composition at a temperature between about 260° F. and about 280° F.

19. A method in accordance with claim 14 further comprising mixing at least one of a perfluoro alkyl acrylic copolymer and a perfluoro alkyl methacrylic copolymer with a solvent to form the coating composition.
